(19) United States
(12) Patent Application Publication
(10) Pub. No.: US 2026/0195230 A1
(43) Pub. Date: Jul. 9, 2026

(54) METHOD AND APPARATUS FOR DETECTING VIRTUAL DESKTOP PERFORMANCE, DEVICE, STORAGE MEDIUM, AND PROGRAM

(71) Applicants: CHINA MOBILE (SUZHOU) SOFTWARE TECHNOLOGY CO., LTD., Suzhou, Jiangsu (CN); CHINA MOBILE COMMUNICATIONS GROUP CO., LTD., Beijing (CN)

(72) Inventors: Tongfei ZHOU, Suzhou (CN); Haobing TIAN, Suzhou (CN)

(21) Appl. No.: 19/128,205

(22) PCT Filed: Nov. 22, 2023
(86) PCT No.: PCT/CN2023/133274

§ 371 Date: May 8, 2025

(30) Foreign Application Priority Data
Nov. 25, 2022 (CN) 202211489474.8

(51) Int. Cl. G06F 11/34; G06F 9/451; H04L 43/12; H04L 69/16; H04L 69/22

(52) U.S. Cl. CPC G06F 11/3409; G06F 9/452; H04L 43/12; H04L 69/16; H04L 69/22

(57) ABSTRACT

Embodiments of the present application relate to the technical field of desktop transmission, and disclose a method for detecting virtual desktop performance. The method includes: sending a detection message to a desktop transmission protocol layer (110); receiving a response message sent by the desktop transmission protocol layer according to the detection message (120); and performing transmission performance analysis on the desktop transmission protocol layer according to the response message (130).

### CROSS-REFERENCE TO RELATED APPLICATION

This application is filed based on and claims priority to Chinese patent application No. 202211489474.8, “Method, apparatus, and device for probing virtual desktop performance, and storage medium” filed on Nov. 25, 2022, the contents of which are hereby incorporated by reference in its entirety.

### TECHNICAL FIELD

Embodiments of the disclosure relate to the technical field of desktop transmission, and in particular to a method, apparatus, and device for probing virtual desktop performance, storage medium, and program.

### BACKGROUND

Currently, a desktop transmission protocol is an important component of cloud desktop solutions, which specifies a method of data transmission between a cloud host and a cloud terminal. An efficient desktop transmission protocol utilizes high-performance algorithms to achieve faster data transmission and higher utilization of cloud host resources, thereby delivering cloud desktop solutions characterized by low latency, clear audio, high-definition and smooth video, and high user density. However, the existing mainstream virtual desktop transmission protocols all have certain shortcomings, such as low image data compression rate, high bandwidth consumption, delayed response in scenarios with intensive operations, and data packet loss, etc., all of which are key factors affecting user experience. In practical operation and usage, these problems result in a degraded user experience.

However, in the prior art, there is no effective probing method to effectively probe transmission performance of a virtual desktop.

### SUMMARY

In view of the above problems, the embodiments of the disclosure provide a method, apparatus, and device for probing virtual desktop performance, a computer storage medium, and a program, which are configured to address the problem in the prior art where there is no effective probing method to effectively probe transmission performance of a virtual desktop.

According to an aspect of the embodiments of the disclosure, there is provided a method for probing virtual desktop performance, applied to a probe service component in a virtual transmission desktop infrastructure, and the method includes the following operations.

At least one probing packet is transmitted to a desktop transmission protocol layer.

At least one response packet transmitted by the desktop transmission protocol layer based on the at least one probing packet is received.

Based on the at least one response packet, transmission performance analysis is performed on the desktop transmission protocol layer.

In an optional embodiment, before the at least one probing packet is transmitted to the desktop transmission protocol layer, the method includes the following operations.

Agreed actions, agreed coding, and execution parameters corresponding to the agreed actions configured with the desktop transmission protocol layer are obtained.

The at least one probing packet is generated based on the agreed actions, the agreed coding, and the execution parameters corresponding to the agreed actions.

In an optional embodiment, the operation that the at least one probing packet is generated based on the agreed actions, the agreed coding, and the execution parameters corresponding to the agreed actions includes the following operations.

A request body of the at least one probing packet is generated based on the agreed actions, the agreed coding, and the execution parameters corresponding to the agreed actions.

A protocol header and an operation code are added to the request body, to generate application layer protocol data.

The application layer protocol data is assembled with an underlying transmission control protocol (TCP) packet field, to obtain the at least one probing packet.

In an optional embodiment, before based on the at least one response packet, the transmission performance analysis is performed on the desktop transmission protocol layer, the method further includes the following operation.

A user-configured key performance indicator to be detected is obtained.

The operation that based on the at least one response packet, the transmission performance analysis is performed on the desktop transmission protocol layer includes that: based on the at least one response packet, the key performance indicator to be detected for the desktop transmission protocol layer is analyzed, and an analysis result is obtained.

In an optional embodiment, the key performance indicator to be detected includes packet round-trip delay; and the operations that based on the at least one response packet, the key performance indicator to be detected for the desktop transmission protocol layer is analyzed, and the analysis result is obtained include the following operations.

A timestamp of the at least one probing packet and a timestamp of the at least one response packet are obtained.

The packet round-trip delay is calculated based on a difference between the timestamp of the at least one probing packet and the timestamp of the at least one response packet.

In an optional embodiment, the key performance indicator to be detected includes a packet loss rate; and the operations that based on the at least one response packet, the key performance indicator to be detected for the desktop transmission protocol layer is analyzed, and the analysis result is obtained include the following operations.

A number of all probing packets and a number of all response packets are obtained.

The packet loss rate is determined based on a ratio of a difference between the number of all the probing packets and the number of all the response packets to the number of all the probing packets.

In an optional embodiment, the method further includes the following operations.

At least one data packet transmitted by the desktop transmission protocol layer is received through a proxy service.

Based on the at least one data packet, the transmission performance analysis is performed on the desktop transmission protocol layer.

According to another aspect of the embodiments of the disclosure, there is provided an apparatus for probing virtual desktop performance, applied to a probe service component in a virtual transmission desktop infrastructure, and the apparatus includes a transmitting module, a receiving module, and an analyzing module.

The transmitting module is configured to transmit at least one probing packet to a desktop transmission protocol layer.

The receiving module is configured to receive at least one response packet transmitted by the desktop transmission protocol layer based on the at least one probing packet.

The analyzing module is configured to perform, based on the at least one response packet, transmission performance analysis on the desktop transmission protocol layer.

According to another aspect of the embodiments of the disclosure, there is provided a device for probing virtual desktop performance, including: a processor, a memory, a communication interface, and a communication bus. The processor, the memory, and the communication interface communicate with each other through the communication bus.

The memory is configured to store at least one executable instruction, and the at least one executable instruction causes the processor to execute the method for probing virtual desktop performance.

According to yet another aspect of the embodiments of the disclosure, there is provided a computer-readable storage medium, having stored thereon at least one executable instruction that, when executed on a device for probing virtual desktop performance, causes the device for probing virtual desktop performance to execute the method for probing virtual desktop performance.

In the embodiments of the disclosure, at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Therefore, it is capable of probing key performance indicators of the accessed desktop transmission protocol, and providing real-time feedback to the accessed desktop transmission protocol, thereby improving the quality of desktop transmission.

The above description is merely an overview of the technical solution in the embodiments of the disclosure. In order to understand the technical means of the embodiments of the disclosure more clearly, the technical means may be implemented according to the content of the specification. Furthermore, to make the above and other objectives, features, and advantages of the embodiments of the disclosure more apparent and understandable, specific implementations of the disclosure are provided below.

### BRIEF DESCRIPTION OF THE DRAWINGS

The drawings are merely intended to illustrate the embodiments and are not considered as limitations on the disclosure. Moreover, throughout the drawings, the same reference symbols are used to denote the same components. In the drawings:

FIG. 1 shows a schematic flowchart of a method for probing virtual desktop performance according to an embodiment of the disclosure;

FIG. 2 shows a schematic diagram of an application environment of a method for probing virtual desktop performance according to an embodiment of the disclosure;

FIG. 3 shows a schematic diagram of generation of a probing packet in a method for probing virtual desktop performance according to an embodiment of the disclosure;

FIG. 4 shows a schematic flowchart of active probing in a method for probing virtual desktop performance according to an embodiment of the disclosure;

FIG. 5 shows a schematic flowchart of passive probing in a method for probing virtual desktop performance according to another embodiment of the disclosure;

FIG. 6 shows a schematic structural diagram of an apparatus for probing virtual desktop performance according to an embodiment of the disclosure; and

FIG. 7 shows a schematic structural diagram of a device for probing virtual desktop performance according to an embodiment of the disclosure.

### DETAILED DESCRIPTION

Exemplary embodiments of the disclosure will be described in more detail below with reference to the drawings. Although the exemplary embodiments of the disclosure are shown in the drawings, it should be understood that the disclosure may be implemented in various forms and should not be limited to the embodiments described herein.

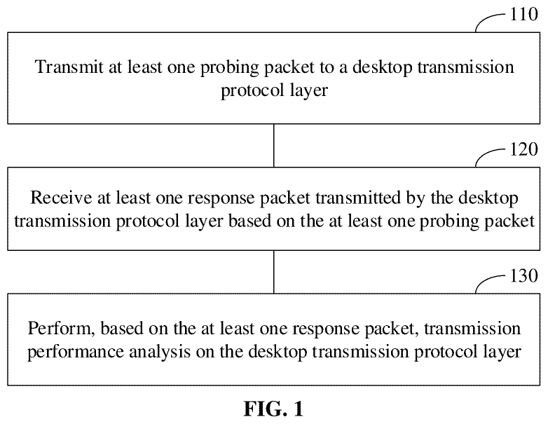

FIG. 1 shows a flowchart of a method for probing virtual desktop performance according to an embodiment of the disclosure. The method is executed by a device for probing virtual desktop performance. The device for probing virtual desktop performance may be a computer device, a terminal device, or more specifically, a virtual desktop device. In an embodiment of the disclosure, the device for probing virtual desktop performance is a probe service component arranged in a virtual desktop. As shown in FIG. 1, the method includes the following operations 110 to 130.

At operation 110, at least one probing packet is transmitted to a desktop transmission protocol layer.

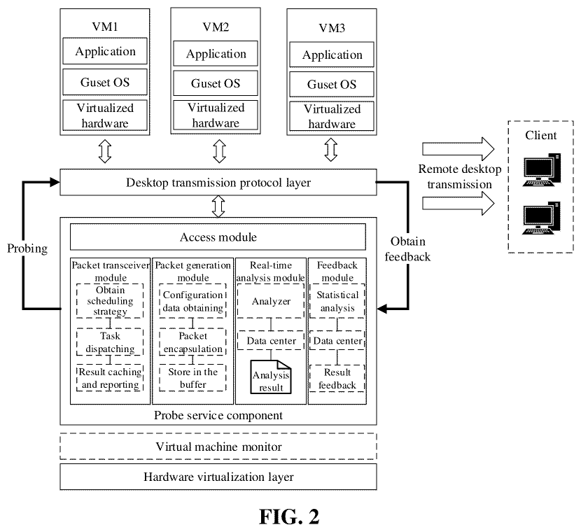

In an embodiment of the disclosure, as shown in FIG. 2, a probe service component is arranged between a desktop transmission protocol layer and a hardware virtualization layer. The probe service component is configured to probe key performance indicators of various cloud desktop transmission protocols for probing performance. Herein the desktop transmission protocol (desktop transmission protocol layer) serves as a bridge between a virtual computer and a user terminal, and is deployed on both the client and server sides. The desktop transmission protocol (desktop transmission protocol layer) is configured to transmit visual information generated by the virtual computer and receive operational instructions from the user terminal. Herein the key performance indicators include packet round-trip delay, packet loss rate, coding efficiency, data compression rate, bitstream of transmission protocol, frame rate, instruction density and other performance indicators during transmission.

Herein, when accessing the probe service component, the transmission protocol needs to pre-obtain a configured key performance indicator to be detected, a calculation scheme of the key performance indicator, and a probing strategy, and agree with the desktop transmission protocol layer on a frequency, a probing target, and related agreed actions, etc. Therefore, the probe service component obtains agreed actions, agreed coding, and execution parameters corresponding to the agreed actions with the desktop transmission protocol layer pre-configured by a user. Herein the execution parameters corresponding to the agreed actions are payload data, which carries the execution parameters corresponding to the agreed actions. For examples, agreed actions and action coding are illustrated in Table 1 as follows:

TABLE 1
A greed actions and action coding

| A greed action | Action coding |
|---|---|
| Obtaining channel type | CHANNEL_GET |
| Obtaining coding algorithm | ENDRYPT_TYPE_GET |
| Obtaining data key | ENCRYPTION_KEY_GET |
| Configuring probing data | PROBE_CONFIG_SET |

Herein since the probe service component may pre-configure the key performance indicator, the calculation scheme, and the probing strategy, the probe service component may flexibly interface with desktop transmission protocols under different virtual desktop infrastructure (VDI), probe the desktop transmission protocols from a perspective of an observer outside the protocol infrastructure, and analyze and provide real-time feedback on probing results, enabling the desktop transmission protocol to intuitively assess the network environment in which the protocol is located and make corresponding feedback.

In an embodiment of the disclosure, after determining the agreed actions, the agreed coding, and the execution parameters corresponding to the agreed actions, the probe service component generates corresponding probing packet(s) based on the agreed actions, the agreed coding, and the execution parameters corresponding to the agreed actions.

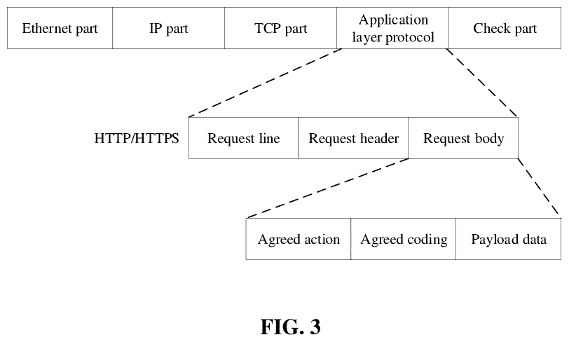

When generating a probing packet, the agreed action, the agreed coding, and the execution parameters corresponding to the agreed action for the probing packet are first determined based on a type of probing packet corresponding to the key performance indicator to be detected. As shown in FIG. 3, an embodiment of the disclosure generates a request body of the probing packet based on the agreed action, the agreed coding, and the execution parameters corresponding to the agreed action; adds a protocol header and an operation code (request header and request line) to the request body, to generate application layer protocol data; and assembles the application layer protocol data with an underlying transmission control protocol (TCP) packet field, to obtain the probing packet. Specifically, the request body of the probing packet is an application data part, which determines the probing action to be performed by the probe service component. The application layer protocol data is generated based on the packet data content. The process of generating transmission layer content involves assembling the application layer protocol data with the underlying TCP packet field, which is mainly used for assembling the content of the underlying TCP packet field. Herein different probing packets may be used for probing different key performance indicators.

After generating the probing packet, the probe service component transmits the probing packet according to a preset probing strategy, transmitting one or more generated probing packets to the desktop transmission protocol layer, so that the desktop transmission protocol layer may response. Herein the preset probing strategy includes a scheduling strategy and a task dispatching mechanism, and the preset probing strategy is pre-configured by the probe service component based on a probing requirement for a key probing indicator.

At operation 120, at least one response packet transmitted by the desktop transmission protocol layer based on the at least one probing packet is received.

After transmitting a probe packet, the probe service component determines whether reception of a response packet from the desktop transmission protocol layer has timed out. If the response packet is not received after the timeout, the probing packet is retransmitted to the desktop transmission protocol layer. If the response packet is received without timing out, the response packet is obtained and cached.

At operation 130, based on the at least one response packet, transmission performance analysis is performed on the desktop transmission protocol layer.

After receiving the at least one response packet, the probe service component analyzes the key performance indicator to be detected for the desktop transmission protocol layer based on the at least one response packet, and obtains an analysis result.

In an embodiment of the disclosure, when the key performance indicator to be detected is packet round-trip delay, a timestamp of the probing packet and a timestamp of the response packet are obtained. The packet round-trip delay is calculated based on a difference between the timestamp of the probing packet and the timestamp of the response packet, thereby determining the packet round-trip delay of the desktop transmission protocol layer. When the key performance indicator to be detected is a packet loss rate, a number of all probing packets and a number of all response packets are obtained. The packet loss rate is determined based on a ratio of a difference between the number of all the probing packets and the number of all the response packets to the number of all the probing packets. In an embodiment of the disclosure, when the key performance indicator to be detected is coding efficiency, the agreed action included in the transmitted probing packet is a coding action, and the response packet includes coded data. The probe service component analyzes the coded data and coding manner in the received response packet, to determine the coding efficiency of the desktop transmission protocol layer. When the key performance indicator to be detected is data compression efficiency, the agreed action included in the transmitted probing packet is data compression. The data compression rate of the desktop transmission protocol layer may be determined based on a size and compression manner of compressed data in the response packet.

After obtaining probing results, an embodiment of the disclosure further performs statistical analysis on all probing results and clears out analysis results that have lost their timeliness. Feedbacks are provided to all accessed desktop transmission protocols, and probing results of agreed key performance indicators are fed back to a service side corresponding to the desktop transmission protocol layer in a form of service interface. This allows the server side to adjust the transmission strategy based on the transmission quality, to ensure a smooth user experience during usage. Herein the packet loss rate is related to the length and transmission frequency of data packets. Therefore, after the packet loss rate is obtained, the packet loss rate may be transmitted to the desktop transmission protocol layer to enable the desktop transmission protocol layer to adjust the length and frequency of the data packets to be transmitted. For example, by probing key performance of various cloud desktop transmission protocols, probing results are fed back in real time to a server side of the desktop transmission protocol layer through a proxy service. The server side determines whether the transmission quality is well and stable based on the probing results from the probe service component. The server side may determine whether the transmission quality is well and stable based on a configured performance item threshold. If a probing result of performance item is greater than the performance threshold, it indicates that the transmission effect meets the expectation, and the server side will not trigger adjustments to the transmission strategy. If the probing result is below the performance threshold, it indicates that the transmission effect does not meet the expectation and fails to reach the minimum required performance threshold for specific scenarios. In such cases, the server side of the transmission protocol will adjust the transmission strategy based on the transmission quality, to ensure a smooth user experience during usage. For example, in a high-definition transmission scenario, a bitstream threshold of the image transmission channel is 4 Mb/s, but the probing result is 2.4 Mb/s, then a strategy adjustment action on the server side is triggered. The server adjusts the video compression strategy to match the bitstream in a range of 2~3.9 Mb/s as an adaptation, switching to a high-compression-rate coding format such as H.264 or H.265, to complete digital image transmission and ensure a smooth user experience.

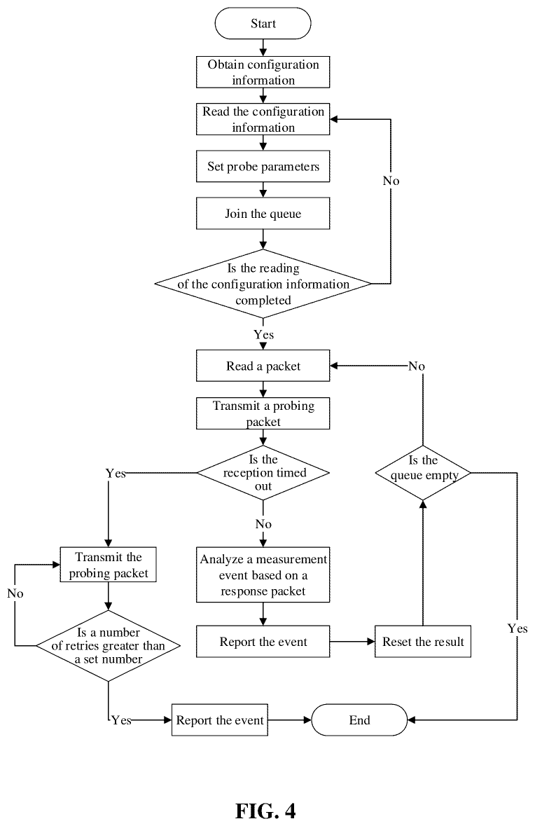

For different key performance indicators, either active probing or passive probing may be adopted. The above operations 110 to 130 represent active probing, through which the probing results of the desktop transmission protocol layer may be obtained actively. As shown in FIG. 4, in a specific implementation, the probe service component, while performing the current probing, obtains configuration information corresponding to the current probing, reads the configuration information, and sets corresponding probe parameters based on the configuration information to generate a probing packet. The probing packet is added to a transmitting queue, and the configuration information of the probing packet is read. Once the reading of the configuration information is complete, the probing packet is read and transmitted to the desktop transmission protocol layer. Whether a response packet is received from the desktop transmission protocol layer within a preset time is determined. If the response packet is not received after the timeout, the probing packet is retransmitted. If a number of retries of transmitting the probing packet reaches a preset limit, an abnormal event is generated and reported. If the response packet is received within the preset time, a probing event is analyzed based on the response packet, a probing result is generated, and the probing result is reported to the data center and the server side of the desktop transmission protocol layer. After the current probing is completed, the result is reset, and the transmitting queue is cleared and continues to wait for a probing packet.

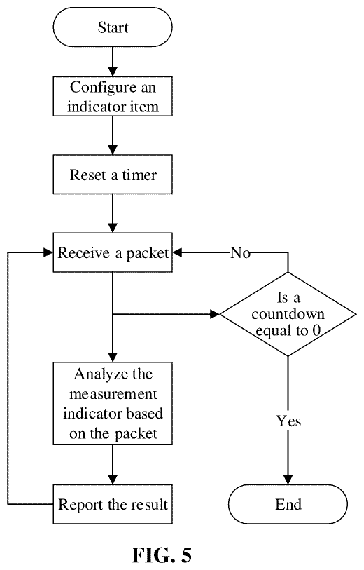

In an embodiment of the disclosure, passive probing is further included. Specifically, the probing frequency, the agreed actions, and the agreed coding, etc. for key performance indicators during passive probing are pre-negotiated with the desktop transmission protocol. Data packet(s) transmitted by the server of the desktop transmission protocol layer is received through a proxy service. Based on the data packet(s), transmission performance analysis is performed on the desktop transmission protocol layer. Specifically, as shown in FIG. 5, a key performance indicator item that needs to be detected is configured, and related configuration information is transmitted to the desktop transmission protocol layer. The timer is reset, and data packet(s) transmitted by the desktop transmission protocol is received within the preset time. The key performance indicator is analyzed based on the data packet(s).

In the embodiments of the disclosure, at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Therefore, it is capable of probing key performance indicators of the accessed desktop transmission protocol, and providing real-time feedback to the accessed desktop transmission protocol, thereby improving the quality of desktop transmission.

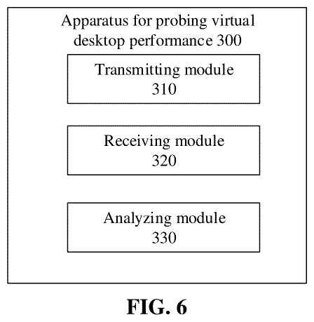

FIG. 6 shows a schematic structural diagram of an apparatus for probing virtual desktop performance according to an embodiment of the disclosure. As shown in FIG. 6, the apparatus 300 is applied to a probe service component in a virtual transmission desktop infrastructure, and includes a transmitting module 310, a receiving module 320, and an analyzing module 330.

The transmitting module 310 is configured to transmit at least one probing packet to a desktop transmission protocol layer.

The receiving module 320 is configured to receive at least one response packet transmitted by the desktop transmission protocol layer based on the at least one probing packet.

The analyzing module 330 is configured to perform, based on the at least one response packet, transmission performance analysis on the desktop transmission protocol layer.

In an optional embodiment, before transmitting the at least one probing packet to the desktop transmission protocol layer, the apparatus further includes a configuring module and a generating module.

The configuring module is configured to obtain agreed actions, agreed coding, and execution parameters corresponding to the agreed actions configured with the desktop transmission protocol layer.

The generating module is configured to generate the at least one probing packet based on the agreed actions, the agreed coding, and the execution parameters corresponding to the agreed actions.

In an optional embodiment, the operation of generating the at least one probing packet based on the agreed actions, the agreed coding, and the execution parameters corresponding to the agreed actions includes the following operations.

A request body of the at least one probing packet is generated based on the agreed actions, the agreed coding, and the execution parameters corresponding to the agreed actions.

A protocol header and an operation code are added to the request body, to generate application layer protocol data.

The application layer protocol data is assembled with an underlying transmission control protocol (TCP) packet field, to obtain the at least one probing packet.

In an optional embodiment, before performing, based on the at least one response packet, the transmission performance analysis on the desktop transmission protocol layer, the apparatus further includes a configuring module.

The configuring module is configured to obtain a user-configured key performance indicator to be detected.

The analyzing module 330 is further configured to analyze, based on the at least one response packet, the key performance indicator to be detected for the desktop transmission protocol layer, and obtain an analysis result.

In an optional embodiment, the key performance indicator to be detected includes packet round-trip delay. The operations of analyzing, based on the at least one response packet, the key performance indicator to be detected for the desktop transmission protocol layer, and obtaining the analysis result include the following operations.

A timestamp of the at least one probing packet and a timestamp of the at least one response packet are obtained.

The packet round-trip delay is calculated based on a difference between the timestamp of the at least one probing packet and the timestamp of the at least one response packet.

In an optional embodiment, the key performance indicator to be detected includes a packet loss rate. The operations of analyzing, based on the at least one response packet, the key performance indicator to be detected for the desktop transmission protocol layer, and obtaining the analysis result include the following operations.

A number of all probing packets and a number of all response packets are obtained.

The packet loss rate is determined based on a ratio of a difference between the number of all the probing packets and the number of all the response packets to the number of all the probing packets.

In an optional embodiment, the apparatus further includes a data packet module.

The data packet module is configured to receive at least one data packet transmitted by the desktop transmission protocol layer through a proxy service.

The analyzing module 330 is further configured to perform, based on the at least one data packet, the transmission performance analysis on the desktop transmission protocol layer.

The specific operating process of the apparatus for probing virtual desktop performance in the embodiments of the disclosure is generally consistent with the specific implementation operations of the above method embodiments, and is not repeated herein.

In the embodiments of the disclosure, at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Therefore, it is capable of probing key performance indicators of the accessed desktop transmission protocol, and providing real-time feedback to the accessed desktop transmission protocol, thereby improving the quality of desktop transmission.

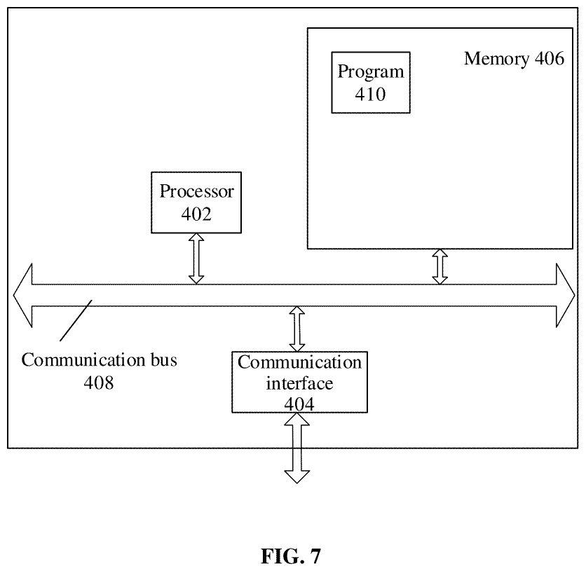

FIG. 7 shows a schematic structural diagram of a device for probing virtual desktop performance according to an embodiment of the disclosure. The embodiment of the disclosure does not limit the specific implementation of the device for probing virtual desktop performance.

As shown in FIG. 7, the device for probing virtual desktop performance may include: a processor 402, a communication interface 404, a memory 406, and a communication bus 408.

The processor 402, the communication interface 404, and the memory 406 communicate with each other through the communication bus 408. The communication interface 404 is configured to communication with network elements of other devices, such as clients or other servers. The processor 402 is configured to execute a program 410 and may specifically execute the related operations in the above method embodiments for probing virtual desktop performance.

Specifically, the program 410 may include a program code that includes a computer executable instruction.

The processor 402 may be a central processing unit (CPU), an application specific integrated circuit (ASIC), or one or more integrated circuits configured to implement the embodiments of the disclosure. One or more processors included in the device for probing virtual desktop performance may be of the same type, such as one or more CPUs. The one or more processors included in the device for probing virtual desktop performance may also be different types of processors, such as one or more CPUs and one or more ASICs.

The memory 406 is configured to store the program 410. The memory 406 may include high-speed random access memory (RAM), and may further include non-volatile memory, such as at least one disk storage.

The program 410 may specifically be called by the processor 402 to cause the device for probing virtual desktop performance to perform the following operations.

At least one probing packet is transmitted to a desktop transmission protocol layer.

At least one response packet transmitted by the desktop transmission protocol layer based on the at least one probing packet is received.

Based on the at least one response packet, transmission performance analysis is performed on the desktop transmission protocol layer.

In an optional embodiment, before transmitting the at least one probing packet to the desktop transmission protocol layer, the method includes the following operations.

Agreed actions, agreed coding, and execution parameters corresponding to the agreed actions configured with the desktop transmission protocol layer are obtained.

The at least one probing packet is generated based on the agreed actions, the agreed coding, and the execution parameters corresponding to the agreed actions.

In an optional embodiment, the operation of generating the at least one probing packet based on the agreed actions, the agreed coding, and the execution parameters corresponding to the agreed actions includes the following operations.

A request body of the at least one probing packet is generated based on the agreed actions, the agreed coding, and the execution parameters corresponding to the agreed actions.

A protocol header and an operation code are added to the request body, to generate application layer protocol data.

The application layer protocol data is assembled with an underlying transmission control protocol (TCP) packet field, to obtain the at least one probing packet.

In an optional embodiment, before performing, based on the at least one response packet, the transmission performance analysis on the desktop transmission protocol layer, the method includes the following operations.

A user-configured key performance indicator to be detected is obtained.

Based on the at least one response packet, the key performance indicator to be detected for the desktop transmission protocol layer is analyzed, and an analysis result is obtained.

In an optional embodiment, the key performance indicator to be detected includes packet round-trip delay. The operations of analyzing, based on the at least one response packet, the key performance indicator to be detected for the desktop transmission protocol layer, and obtaining the analysis result include the following operations.

A timestamp of the at least one probing packet and a timestamp of the at least one response packet are obtained.

The packet round-trip delay is calculated based on a difference between the timestamp of the at least one probing packet and the timestamp of the at least one response packet.

In an optional embodiment, the key performance indicator to be detected includes a packet loss rate. The operations of analyzing, based on the at least one response packet, the key performance indicator to be detected for the desktop transmission protocol layer, and obtaining the analysis result include the following operations.

A number of all probing packets and a number of all response packets are obtained.

The packet loss rate is determined based on a ratio of a difference between the number of all the probing packets and the number of all the response packets to the number of all the probing packets.

In an optional embodiment, the method further includes the following operations.

At least one data packet transmitted by the desktop transmission protocol layer is received through a proxy service.

Based on the at least one data packet, the transmission performance analysis is performed on the desktop transmission protocol layer.

In the embodiments of the disclosure, at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Therefore, it is capable of probing key performance indicators of the accessed desktop transmission protocol, and providing real-time feedback to the accessed desktop transmission protocol, thereby improving the quality of desktop transmission.

An embodiment of the disclosure provides a computer-readable storage medium, having stored thereon at least one executable instruction that, when executed on a device for probing virtual desktop performance, causes the device for probing virtual desktop performance to execute the method for probing virtual desktop performance described in any of the above method embodiments.

The at least one executable instruction may specifically be configured to cause the device for probing virtual desktop performance to perform the following operations.

At least one probing packet is transmitted to a desktop transmission protocol layer.

At least one response packet transmitted by the desktop transmission protocol layer based on the at least one probing packet is received.

Based on the at least one response packet, transmission performance analysis is performed on the desktop transmission protocol layer.

In an optional embodiment, before transmitting the at least one probing packet to the desktop transmission protocol layer, the method includes the following operations.

A greed actions, agreed coding, and execution parameters corresponding to the agreed actions configured with the desktop transmission protocol layer are obtained.

The at least one probing packet is generated based on the agreed actions, the agreed coding, and the execution parameters corresponding to the agreed actions.

In an optional embodiment, the operation of generating the at least one probing packet based on the agreed actions, the agreed coding, and the execution parameters corresponding to the agreed actions includes the following operations.

A request body of the at least one probing packet is generated based on the agreed actions, the agreed coding, and the execution parameters corresponding to the agreed actions.

A protocol header and an operation code are added to the request body, to generate application layer protocol data.

The application layer protocol data is assembled with an underlying transmission control protocol (TCP) packet field, to obtain the at least one probing packet.

In an optional embodiment, before performing, based on the at least one response packet, the transmission performance analysis on the desktop transmission protocol layer, the method includes the following operations.

A user-configured key performance indicator to be detected is obtained.

Based on the at least one response packet, the key performance indicator to be detected for the desktop transmission protocol layer is analyzed, and an analysis result is obtained.

In an optional embodiment, the key performance indicator to be detected includes packet round-trip delay. The operations of analyzing, based on the at least one response packet, the key performance indicator to be detected for the desktop transmission protocol layer, and obtaining the analysis result include the following operations.

A timestamp of the at least one probing packet and a timestamp of the at least one response packet are obtained.

The packet round-trip delay is calculated based on a difference between the timestamp of the at least one probing packet and the timestamp of the at least one response packet.

In an optional embodiment, the key performance indicator to be detected includes a packet loss rate. The operations of analyzing, based on the at least one response packet, the key performance indicator to be detected for the desktop transmission protocol layer, and obtaining the analysis result include the following operations.

A number of all probing packets and a number of all response packets are obtained.

The packet loss rate is determined based on a ratio of a difference between the number of all the probing packets and the number of all the response packets to the number of all the probing packets.

In an optional embodiment, the method further includes the following operations.

At least one data packet transmitted by the desktop transmission protocol layer is received through a proxy service.

Based on the at least one data packet, the transmission performance analysis is performed on the desktop transmission protocol layer.

In the embodiments of the disclosure, at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Therefore, it is capable of probing key performance indicators of the accessed desktop transmission protocol, and providing real-time feedback to the accessed desktop transmission protocol, thereby improving the quality of desktop transmission.

An embodiment of the disclosure provides an apparatus for probing virtual desktop performance, which is configured to execute the above method for probing virtual desktop performance.

An embodiment of the disclosure provides a computer program, that is capable of being called by a processor to cause a device for probing virtual desktop performance to execute the method for probing virtual desktop performance in any of the above method embodiments.

An embodiment of the disclosure provides a computer program product, including a computer program stored on a computer-readable storage medium. The computer program includes a program instruction that, when executed on a computer, causes the computer to execute the method for probing virtual desktop performance in any of the above method embodiments.

The algorithms or displays provided herein are not inherently related to any specific computer, virtual system, or other device. Various general-purpose systems may also be used in conjunction with the teachings provided herein. According to the above description, the structures required to construct such systems are obvious. Furthermore, the embodiments of the disclosure are not directed to any specific programming language. It should be understood that the contents of the disclosure described herein may be implemented using various programming languages, and the description of specific languages above is intended to disclose the best implementation of the disclosure.

In the description provided herein, a large number of specific details are explained. However, it may be understood that the embodiments of the disclosure may be practiced without these specific details. In some instances, well-known methods, structures, and techniques are not shown in detail to avoid obscuring the understanding of the description.

Similarly, it should be understood that in order to streamline the disclosure and assist in understanding one or more aspects of the various aspects of the disclosure, the various features in the embodiments of the disclosure are sometimes grouped together into a single embodiment, drawing, or description thereof in the above description of the exemplary embodiments of the disclosure. However, the disclosed method should not be interpreted as reflecting an intention that the claimed disclosure requires more features than those explicitly recited in each claim.

It may be understood by those skilled in the art that the modules in the device in the embodiments may be adaptively changed and arranged in one or more devices different from the embodiments. The modules, units, or components in the embodiments may be combined into one a single module, unit, or component, and the modules, units, or components in the embodiments may be divided into multiple sub-modules, sub-units, or sub-components. Except that at least some of such features and/or processes or units are mutually exclusive, any combination may be used to combine all features disclosed in the description (including accompanying claims, abstract, and drawings) and all processes or units of any method or device so disclosed. Unless explicitly stated otherwise, each feature disclosed in the description (including accompanying claims, abstract, and drawings) may be replaced by alternative features that provide the same, equivalent, or similar purpose.

It should be noted that the above embodiments are intended to illustrate the disclosure rather than limit it, and those skilled in the art may design alternative embodiments without departing from the scope of the appended claims. In the claims, any reference symbols placed between parentheses shall not be constructed as limitations on the claims. The word “include” does not exclude the presence of elements or operations that are not listed in the claims. The word “a” or “an” preceding an element does not exclude the presence of multiple such elements. The disclosure may be implemented by means of hardware including several different elements and by means of a suitably programmed computer. In a unit claim enumerating several apparatuses, several of these apparatuses may be specifically embodied through the same hardware item. The use of words such as first, second, and third does not indicate any order. These words may be interpreted as names. The operations in the above embodiments should not be understood as limiting the order of execution, unless otherwise specified.

### INDUSTRIAL APPLICABILITY

The embodiments of the disclosure relate to the technical field of desktop transmission, and disclose a method for probing virtual desktop performance. The method includes that: at least one probing packet is transmitted to a desktop transmission protocol layer; at least one response packet transmitted by the desktop transmission protocol layer based on the at least one probing packet is received; and based on the at least one response packet, transmission performance analysis is performed on the desktop transmission protocol layer. Through the above method, the embodiments of the disclosure can probe key performance indicators of the accessed desktop transmission protocol, and providing real-time feedback to the accessed desktop transmission protocol, thereby improving the quality of desktop transmission.

1. A method for probing virtual desktop performance, applied to a probe service component in a virtual transmission desktop infrastructure, and comprising:
transmitting at least one probing packet to a desktop transmission protocol layer;
receiving at least one response packet transmitted by the desktop transmission protocol layer based on the at least one probing packet; and
performing, based on the at least one response packet, transmission performance analysis on the desktop transmission protocol layer.

2. The method of claim 1, wherein before transmitting the at least one probing packet to the desktop transmission protocol layer, the method comprises:
obtaining agreed actions, agreed coding, and execution parameters corresponding to the agreed actions configured with the desktop transmission protocol layer; and
generating the at least one probing packet based on the agreed actions, the agreed coding, and the execution parameters corresponding to the agreed actions.

3. The method of claim 2, wherein generating the at least one probing packet based on the agreed actions, the agreed coding, and the execution parameters corresponding to the agreed actions comprises:
generating a request body of the at least one probing packet based on the agreed actions, the agreed coding, and the execution parameters corresponding to the agreed actions;
adding a protocol header and an operation code to the request body, to generate application layer protocol data; and
assembling the application layer protocol data with an underlying transmission control protocol (TCP) packet field, to obtain the at least one probing packet.

4. The method of claim 1, wherein before performing, based on the at least one response packet, the transmission performance analysis on the desktop transmission protocol layer, the method further comprises:
obtaining a user-configured key performance indicator to be detected; and
performing, based on the at least one response packet, the transmission performance analysis on the desktop transmission protocol layer comprising: analyzing, based on the at least one response packet, the key performance indicator to be detected for the desktop transmission protocol layer, and obtaining an analysis result.

5. The method of claim 4, wherein the key performance indicator to be detected comprises packet round-trip delay; and analyzing, based on the at least one response packet, the key performance indicator to be detected for the desktop transmission protocol layer, and obtaining the analysis result comprises:
obtaining a timestamp of the at least one probing packet and a timestamp of the at least one response packet; and
calculating the packet round-trip delay based on a difference between the timestamp of the at least one probing packet and the timestamp of the at least one response packet.

6. The method of claim 4, wherein the key performance indicator to be detected comprises a packet loss rate; and analyzing, based on the at least one response packet, the key performance indicator to be detected for the desktop transmission protocol layer, and obtaining the analysis result comprises:
obtaining a number of all probing packets and a number of all response packets; and
determining the packet loss rate based on a ratio of a difference between the number of all the probing packets and the number of all the response packets to the number of all the probing packets.

7. The method of claim 1, further comprising:
receiving at least one data packet transmitted by the desktop transmission protocol layer through a proxy service; and
performing, based on the at least one data packet, the transmission performance analysis on the desktop transmission protocol layer.

8. (canceled)

9. A device for probing virtual desktop performance, comprising: a processor, a memory, a communication interface, and a communication bus, wherein the processor, the memory, and the communication interface communicate with each other through the communication bus; and
the memory is configured to store at least one executable instruction, and the processor, when executing the at least one executable instruction, is configured to:
transmit at least one probing packet to a desktop transmission protocol layer;
receive at least one response packet transmitted by the desktop transmission protocol layer based on the at least one probing packet; and
perform, based on the at least one response packet, transmission performance analysis on the desktop transmission protocol layer.

10. A non-transitory computer-readable storage medium, having stored thereon at least one executable instruction that, when executed on a device for probing virtual desktop performance, causes the device for probing virtual desktop performance to execute a method for probing virtual desktop performance, comprising:
transmitting at least one probing packet to a desktop transmission protocol layer;
receiving at least one response packet transmitted by the desktop transmission protocol layer based on the at least one probing packet; and
performing, based on the at least one response packet, transmission performance analysis on the desktop transmission protocol layer.

11. (canceled)

12. The device of claim 9, wherein before transmitting the at least one probing packet to the desktop transmission protocol layer, the processor is further configured to:
obtain agreed actions, agreed coding, and execution parameters corresponding to the agreed actions configured with the desktop transmission protocol layer; and
generate the at least one probing packet based on the agreed actions, the agreed coding, and the execution parameters corresponding to the agreed actions.

13. The device of claim 12, wherein in generating the at least one probing packet based on the agreed actions, the agreed coding, and the execution parameters corresponding to the agreed actions, the processor is configured to:
generate a request body of the at least one probing packet based on the agreed actions, the agreed coding, and the execution parameters corresponding to the agreed actions;
add a protocol header and an operation code to the request body, to generate application layer protocol data; and
assemble the application layer protocol data with an underlying transmission control protocol (TCP) packet field, to obtain the at least one probing packet.

14. The device of claim 9, wherein before performing, based on the at least one response packet, the transmission performance analysis on the desktop transmission protocol layer, the processor is further configured to:
obtain a user-configured key performance indicator to be detected; and
perform, based on the at least one response packet, the transmission performance analysis on the desktop transmission protocol layer comprising: analyzing, based on the at least one response packet, the key performance indicator to be detected for the desktop transmission protocol layer, and obtaining an analysis result.

15. The device of claim 14, wherein the key performance indicator to be detected comprises packet round-trip delay; and in analyzing, based on the at least one response packet, the key performance indicator to be detected for the desktop transmission protocol layer, and obtaining the analysis result, the processor is configured to:
obtain a timestamp of the at least one probing packet and a timestamp of the at least one response packet; and
calculate the packet round-trip delay based on a difference between the timestamp of the at least one probing packet and the timestamp of the at least one response packet.

16. The device of claim 14, wherein the key performance indicator to be detected comprises a packet loss rate; and in analyzing, based on the at least one response packet, the key performance indicator to be detected for the desktop transmission protocol layer, and obtaining the analysis result, the processor is configured to:
obtain a number of all probing packets and a number of all response packets; and
determine the packet loss rate based on a ratio of a difference between the number of all the probing packets and the number of all the response packets to the number of all the probing packets.

17. The device of claim 9, wherein the processor is further configured to:
receive at least one data packet transmitted by the desktop transmission protocol layer through a proxy service; and
perform, based on the at least one data packet, the transmission performance analysis on the desktop transmission protocol layer.

18. The non-transitory computer-readable storage medium of claim 10, wherein before transmitting the at least one probing packet to the desktop transmission protocol layer, the method comprises:
obtaining agreed actions, agreed coding, and execution parameters corresponding to the agreed actions configured with the desktop transmission protocol layer; and
generating the at least one probing packet based on the agreed actions, the agreed coding, and the execution parameters corresponding to the agreed actions.

19. The non-transitory computer-readable storage medium of claim 18, wherein generating the at least one probing packet based on the agreed actions, the agreed coding, and the execution parameters corresponding to the agreed actions comprises:
generating a request body of the at least one probing packet based on the agreed actions, the agreed coding, and the execution parameters corresponding to the agreed actions;
adding a protocol header and an operation code to the request body, to generate application layer protocol data; and
assembling the application layer protocol data with an underlying transmission control protocol (TCP) packet field, to obtain the at least one probing packet.

20. The non-transitory computer-readable storage medium of claim 10, wherein before performing, based on the at least one response packet, the transmission performance analysis on the desktop transmission protocol layer, the method further comprises:
obtaining a user-configured key performance indicator to be detected; and
performing, based on the at least one response packet, the transmission performance analysis on the desktop transmission protocol layer comprising: analyzing, based on the at least one response packet, the key performance indicator to be detected for the desktop transmission protocol layer, and obtaining an analysis result.

21. The non-transitory computer-readable storage medium of claim 20, wherein the key performance indicator to be detected comprises packet round-trip delay; and analyzing, based on the at least one response packet, the key performance indicator to be detected for the desktop transmission protocol layer, and obtaining the analysis result comprises:
obtaining a timestamp of the at least one probing packet and a timestamp of the at least one response packet; and
calculating the packet round-trip delay based on a difference between the timestamp of the at least one probing packet and the timestamp of the at least one response packet.

22. The non-transitory computer-readable storage medium of claim 20, wherein the key performance indicator to be detected comprises a packet loss rate; and analyzing, based on the at least one response packet, the key performance indicator to be detected for the desktop transmission protocol layer, and obtaining the analysis result comprises:
obtaining a number of all probing packets and a number of all response packets; and determining the packet loss rate based on a ratio of a difference between the number of all the probing packets and the number of all the response packets to the number of all the probing packets.
